(19) United States
(12) Patent Application Publication
(10) Pub. No.: US 2011/0295433 A1
(43) Pub. Date: Dec. 1, 2011

(54) SYSTEM AND METHOD FOR PROVIDING POWER TO A HYDRAULIC SYSTEM

(75) Inventor: Timothy A. Evans, Edwards, IL (US)

(73) Assignee: Caterpillar, Inc., Peoria, IL (US)

(21) Appl. No.: 12/791,504

(22) Filed: Jun. 1, 2010

(51) Int. Cl. G06F 1/28; G05D 17/02; G05D 7/06

(52) U.S. Cl. 700/282; 700/295; 713/300

(57) ABSTRACT

A method for providing power to a hydraulic system is disclosed. The method includes determining a hydraulic system power demand, determining an energy storage device power demand, and determining a desired parameter of a primary power source based on the hydraulic system power demand. The method further includes providing power to the hydraulic system as a function of the energy storage device power demand and the desired parameter.

### TECHNICAL FIELD

This patent disclosure relates generally to a hydraulic power system, and more particular, to a system and a method for providing power to a hydraulic system in part from a primary power source and in part from an energy storage device.

### BACKGROUND

Hydraulic machines, for example, hydraulic excavators, use engines to drive hydraulic pumps, which in turn provide hydraulic power to cylinders. The engine often operates at a fixed speed regardless of the actual instantaneous power requirement of the machine. Thus, even when power demand is low, the engine runs at an inefficient speed, resulting in excess fuel consumption and engine wear. When power demand is high, however, the engine runs at a high speed and the necessary power can be efficiently delivered to the hydraulic system. As a result, the engine runs at an optimal speed for high power demand tasks, but runs at an inefficient speed for lower power demand tasks.

One exemplary hydraulic machine is a hydraulic excavator, which is useful for a number of tasks, which can be assessed as distinct steps. Excavators are often used to dig trenches. During a typical dig cycle, the excavator begins at the dig step by digging with its bucket into the soil. Next, during the lift and swing step, the excavator lifts the soil into the air and swings towards the dump location, for example a waiting dump truck. During the dump step, the machine dumps the soil at the dump location. Finally, during the return step the excavator swings back to the dig location, while lowering the bucket, and thus is ready for the next dig cycle. During the entirety of the dig cycle, the machine runs at maximum power and thus high engine speed. However, only the dig step and the lift and swing steps require high engine power. The dump and return steps require less power, but the machine typically runs at high speed, thus unnecessarily consuming fuel.

Control systems have been implemented to control power distribution within hydraulic machines during varying power requirement operations. For example, U.S. Pat. No. 7,434,653 to Khalil et al. (“Khalil”) discloses an on demand electro-hydraulic steering system for a work machine. Khalil suggests that the electro-hydraulic steering system described therein may reduce the amount of pressurized fluid used to steer the work machine during many operating scenarios, thereby increasing the amount of pressurized fluid that is available, while steering, for the operation of other, non-steering systems and implements. Nevertheless, Khalil and other known hydraulic systems do not provide power to a hydraulic system as a function of an energy storage device power demand, such as, for example, a state of charge, and as a function of a desired parameter, such as, for example, a desired optimal engine speed.

The disclosed systems and methods are directed to overcoming one or more of the problems set forth above.

### BRIEF SUMMARY OF THE INVENTION

The disclosure describes, in one aspect, a method for providing power to a hydraulic system. The method includes determining a hydraulic system power demand, determining an energy storage device power demand, and determining a desired parameter of a primary power source based on the hydraulic system power demand. The method further includes providing power to the hydraulic system as a function of the energy storage device power demand and the desired parameter.

In another aspect, is disclosed a system for providing power to a hydraulic system operatively connected to a primary power source. The system includes a controller operatively connected to an energy storage device, the primary power source, and the hydraulic system. The controller is adapted to determine a hydraulic system power demand, determine an energy storage device power demand and determine a desired parameter of a primary power source based on the hydraulic system power demand. The system is further adapted to provide power to the hydraulic system as a function of the energy storage device power demand and the desired parameter.

In another aspect, is disclosed a processor readable storage medium containing processor readable code for programming a processor to perform a method that includes determining a hydraulic system power demand by receiving a pilot pressure associated with an input device operatively connected to the hydraulic system. The method further includes determining a state of charge of an energy storage device and determining a desired engine speed of an engine based in part on the pilot pressure. The method includes providing power to the hydraulic system in part from the engine and in part from the energy storage device as a function of the desired engine speed and the state of charge of the energy storage device.

### BRIEF DESCRIPTION OF THE DRAWING(S)

FIG. 1 is schematically illustrates a machine having a system in accordance with an exemplary embodiment of the present disclosure.

FIG. 2 schematically illustrates the system for providing power to a hydraulic system in accordance with an exemplary embodiment of the present disclosure.

FIG. 3 is a logical block diagram of a control system for providing power to the hydraulic system in accordance with an exemplary embodiment of the present disclosure.

### DETAILED DESCRIPTION

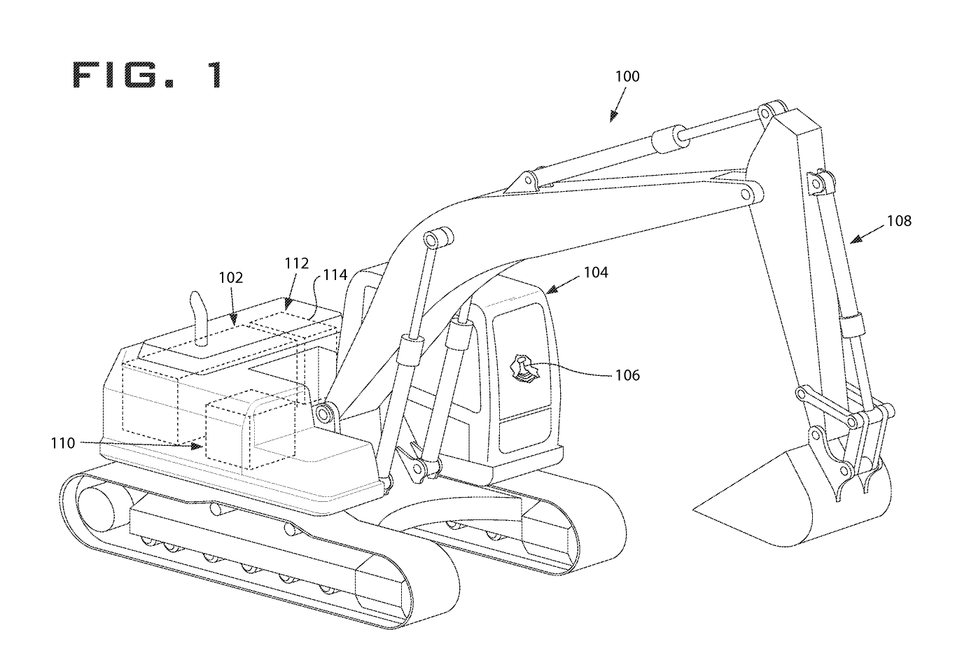

This disclosure relates to systems and methods for providing power to a hydraulic system. An exemplary embodiment of a machine 100 is shown schematically in FIG. 1. The machine 100 may be a hydraulic excavator, as shown, or any other vehicle that has a hydraulic or electro-hydraulic system, such as, for example a loader. The machine 100 includes a primary power source 102. The primary power source 102 may embody an engine that may provide power for the machine 100 and other machine components. Suitable engines may include gasoline powered and diesel powered engines. In one embodiment, the engine may be a diesel engine that generates and transfers power to other components of the machine 100 through a power transfer mechanism, for example, a shaft (not shown), which in turn produces electrical power. The primary power source 102 may produce a mechanical or electrical power output that may be converted to hydraulic power.

The machine 100 may further include an operator station or cab 104 containing controls necessary to operate the machine 100, such as, for example input devices 106 for propelling the machine 100 and for controlling other machine components. The input devices 106 may be embodied as joysticks, levers, buttons, and may be operatively connected to a hydraulic system 108. For simplification purposes, only one input device 106 embodied as a joystick will be discussed and/or shown in the figures.

In some embodiments, the cab 104 may also include interfaces having a display for conveying information to an operator and may include a keyboard, touch screen, or any suitable mechanism for receiving input from the operator to control or operate the machine 100, the hydraulic system 108, and/or other machine 100 components. Alternatively, or additionally, the operator may be located outside of the cab and/or some distance away from the machine 100 and control the machine 100, hydraulic system 108, and/or other machine components remotely.

The hydraulic system 108 may include fluid components, such as, for example, hydraulic actuators or cylinders, tanks, valves, accumulators, orifices, and other suitable components for producing pressurized fluid flow. The hydraulic system 108 may further include fluid sources, such as, for example, one or more hydraulic pumps, which may be embody variable displacement pumps, fixed displacement pumps, variable delivery pumps, or other suitable pressurizing systems. The fluid sources may be drivably connected to the primary power source 102 or may be indirectly connected to the primary power source 102. It is also contemplated that the hydraulic system 108 may include multiple sources of pressurized fluid interconnected to supply pressurized fluid to the hydraulic system 108. In some embodiments, such as, for example, in electro-hydraulic systems, the hydraulic system 108 may include electrical components that cooperate with the fluid components to power and control machine components, including a work tool or an implement.

The machine 100 may further include an energy storage device 110. The energy storage device 110 may embody any appropriate energy storage system such as, for example, a battery, an ultracapacitor, and/or a hydraulic accumulator. In the illustrated embodiment, the energy storage device 110 is adaptable to provide energy, additionally, or alternatively, to provide power to the machine 100 and to other machine components. For example, electric energy may be stored in the energy storage device 110 during low load conditions associated with the primary power source 102. Additionally, or alternatively, the energy storage device 110 may provide additional energy and thus additional power beyond the energy or power produced by the primary power source 102, and may prevent the primary power source 102 from lugging or stalling.

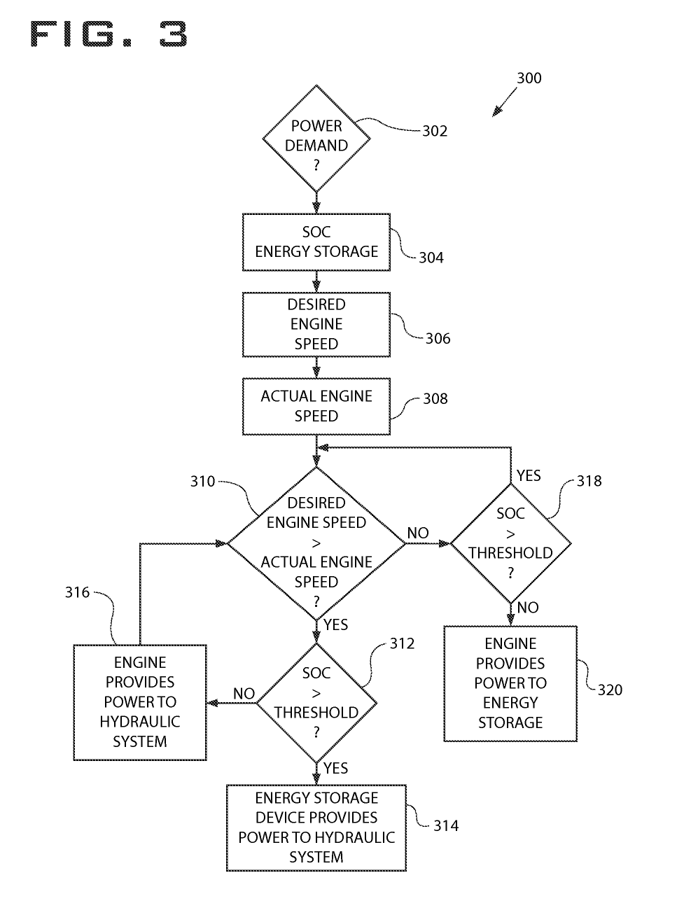

Further, the energy storage device 110, as explained in more detail below, and, as shown, for example in FIG. 3, may permit the primary power source 102 to be operated at a relatively low speed when less than full power is demanded, for example, to operate the machine 100 and to continue to meet the variable power demands of the machine 100 without lugging out or stalling. For example, the energy storage device 110 may provide additional power to the machine 100 during an increased power demand to supply sufficient power while a speed associated with the power source 102, such as, for example, an engine speed of the engine, increases to accommodate the increased power demand (e.g. an increased load).

In other words, the energy storage device 110 may be configured to store energy while the machine 100 is operating under conditions that do not require the full capacity of the primary power source 102 to supply power. Alternatively, or additionally, the energy as such stored may be recovered and used when the machine 100 requires a greater power supply than the full capacity of the primary power source 102 allows (i.e. the power required exceeds capacity of primary power source 102) or used to provide energy more efficiently from the primary source even when less than full capacity is required.

The machine 100 also includes a control system 112 having a controller 114 suitable for controlling the hydraulic system 108. As shown in FIGS. 1 & 2, the input device 106 may be operatively connected to the controller 114 and may be adapted to receive input from the operator indicative of a desired movement of the implement or of the machine 100, and thus may represent a power demand associated with the hydraulic system 108 for performing such implement and/or machine 100 movements.

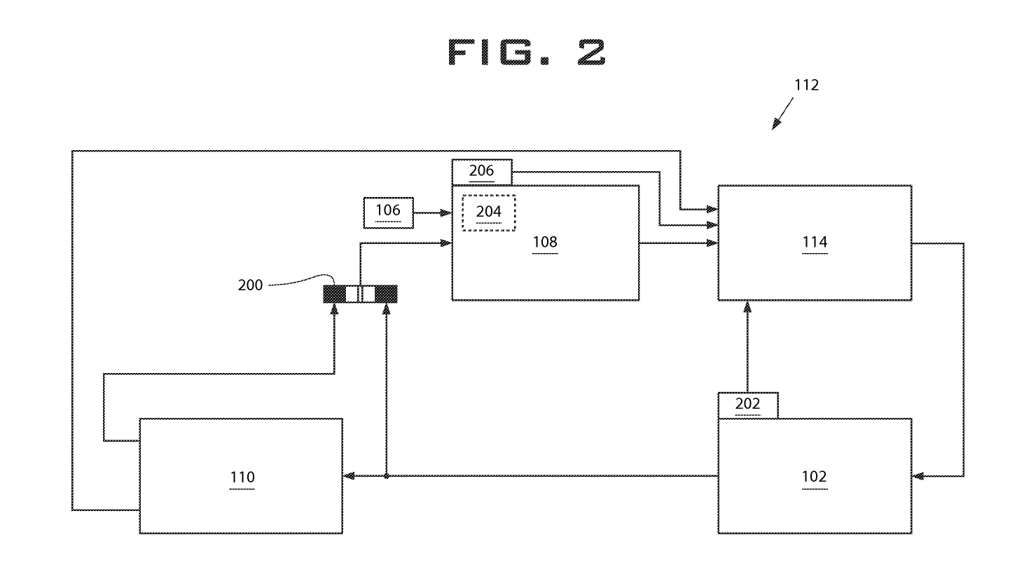

An embodiment of the control system 112 is shown schematically in FIG. 2. The control system 112 operatively connects the input device 106 and the hydraulic system 108. For example, the input device 106 may be in communication with the controller 114 and the controller 114 may be in communication with one or more of the electrical components of the hydraulic system 108, such as, for example, an electronically controlled or solenoid valve actuator. In some embodiments, an electrical signal may be associated with the input device 106 and may be indicative of the power demand on the hydraulic system 108. In the illustrated embodiment, the control system 112 further operatively connects the input device 106, the hydraulic system 108, the controller 114, the primary power source 102, and the energy storage device 110.

The controller 114 may be adapted to coordinate the distribution of power to the hydraulic system 108. In some embodiments, the controller 114 may control the primary power source 102 and the energy storage device 110 cooperatively to optimize the primary power source speed and/or the primary power source load and thus reduce emissions and increase fuel efficiency. In the illustrated embodiment, the control system 112 includes a control mechanism 200, such as, for example, a combiner or sum block, adapted to manage the provision of energy to the hydraulic system 108 from the primary power source 102 and the energy storage device 110.

For example, a portion of the energy required to meet the power demand associated with the hydraulic system 108 may be provided by the primary power source 102 and a portion of the energy required to meet the power demand associated with the hydraulic system 108 may be provided by the energy storage device 110. The control system 112 may be adapted to provide the total energy required to meet the power demand associated with the hydraulic system 108 entirely from the primary power source 102, entirely from the energy storage device 110, and/or by providing the total energy required in part from the primary power source 102 and in part from the energy storage device 110.

The control system 112 may also include one or more sensors, such as, for example, speed sensors, pressure sensors, temperature sensors, and other suitable sensors, that are adapted to measure, collect, and/or transmit signals (i.e. data) to the controller 114. The speed sensors may be associated with the primary power source 102 and may be adapted to monitor the primary power source speed. In the illustrated embodiment, the speed sensors embody one or more engine speed sensors 202 associated with the primary power source 102 embodying, for example, the engine.

The controller 114 may be adapted to monitor the engine speed to manage the provision of fluid power in the hydraulic system 108 and to operate the engine and other components that drive fluid sources 204, such as, for example, the one or more hydraulic pumps, at lower speeds while still providing the same work or energy. The fluid flow required by the hydraulic system 108 determines the power required and used by the pumps 204 and in turn determines the power demand associated with the engine 102 and thus determines the engine speed. The controller 114 may be configured to control engine speed directly or indirectly. As is generally known, the operator may also manually regulate or control engine speed.

The pressure sensors may be associated with the fluid components and/or may be associated with fluid lines interconnecting the fluid components. The pressure sensors may be adapted to monitor fluid pressures within and throughout the hydraulic system 108. In the illustrated embodiment, the pressure sensors embody one or more pilot pressure sensors 206 associated with the input devices 106 and are configured to generate signals indicative of a power demand associated with the hydraulic system 108. For example, the controller 114 may associate a signal indicative of an increased pilot pressure with a new operating status of the machine 100 that may demand more fluid power to accomplish, for example, a predetermined task related to the new operating status.

In other words, if the pilot pressure associated with input device 106 increases, the controller 114 determines that a power intensive task is to be accomplished and that more power is demanded. In addition, the controller 114 may associate a decreased pilot pressure with a new operating status of the machine 100 that may demand less fluid power (e.g. a lower power intensive task is to be accomplished). In some embodiments, the pilot pressure sensors 206 may detect a manipulation of the input device 106. Although the hydraulic system 108 employs pilot pressure sensors 206, it is contemplated that the sensors could be any sensors configured to monitor parameters indicative of the power demands on the hydraulic system 108, including electrical signals associated with electro-hydraulic systems.

The controller 114 may also monitor a state of charge of the energy storage device 110 and may be adapted to selectively charge and/or discharge the energy storage device 110 based on the state of charge. The controller 114 may be adapted to determine the state of charge based at least in part on a property associated with the energy storage device 110, such as, for example, an electrical property of a battery. It is also contemplated that the controller 114, in some embodiments, may determine the state of charge based on pressures associated with the energy storage device 110, such as, for example, pressures within or between hydraulic accumulators, and/or pressures associated generally with the hydraulic system 108.

In some embodiments, the energy storage device 110 may be adapted to hold a supply of energy at a desired energy level and to provide the desired energy level to the hydraulic system 108 according to the power demands on the hydraulic system 108. For example, the energy storage device 110 may be maintained above a predetermined threshold sufficient to provide power commensurate with or satisfactory of the power demand of the hydraulic system 108. In the illustrated embodiment, the control system 112 is adapted to maintain an energy level in the energy storage device 110 at a substantially constant level, for example, at a fully-charged level.

The controller 114 may include one or more control modules (e.g. ECMs, ECUs, etc.). The one or more control modules may include processing units, memory, sensor interfaces, and/or control signal interfaces (for receiving and transmitting signals). The processing units may represent one or more logic and/or processing components used by the control system 112 to perform certain communications, control, and/or diagnostic functions. For example, the processing units may be adapted to execute routing information among devices within and/or external to the control system 112. The one or more control modules may communicate to each other and to other components within and interfacing the control system 112 using any appropriate communication mechanisms, such as, for example, a CAN bus.

Further, the processing units may be adapted to execute instructions, including from a storage device, such as memory. The one or more control modules may each be responsible for executing software code for the control system 112. The one or more control modules may include a plurality of processing units, such as one or more general purpose processing units and or special purpose units (for example, ASICS, FPGAs, etc.). In certain embodiments, functionality of the processing unit may be embodied within an integrated microprocessor or microcontroller, including integrated CPU, memory, and one or more peripherals. The memory may represent one or more known systems capable of storing information, including, but not limited to, a random access memory (RAM), a read-only memory (ROM), magnetic and optical storage devices, disks, programmable, erasable components such as erasable programmable read-only memory (EPROM, EEPROM, etc.), and nonvolatile memory such as flash memory.

### INDUSTRIAL APPLICABILITY

The industrial applicability of the systems and methods for providing power to a hydraulic system described herein will be readily appreciated from the foregoing discussion. One exemplary machine suited to the disclosure is an excavator. Similarly, the systems and methods described can be adapted to a large variety of machines and tasks. For example, backhoe loaders, compactors, feller bunchers, forest machines, industrial loaders, skid steer loaders, wheel loaders and many other machines can benefit from the systems and methods described.

In accordance with certain embodiments, the control system 112 is adapted to provide power to the hydraulic system 108, to determine a hydraulic system power demand, to determine a energy storage device power demand, to determine a desired parameter of the primary power source 102 based on the hydraulic system power demand, and to provide power to the hydraulic system 108 as a function of the energy storage device power demand and the desired parameter, such as, for example, the engine speed.

FIG. 3 illustrates an exemplary embodiment of the control system 112 and the process (300) of providing power to a hydraulic system 108 in part from the primary power source 102 and in part from the energy storage device 110. The controller 114 is adapted to determine the hydraulic system power demand (Step 302). The controller 114 is further adapted to determine the energy storage device power demand (Step 304). In the illustrated embodiment, the energy storage device power demand embodies the state of charge of the energy storage device 110.

The controller 114 determines the desired parameter of the primary power source 102 based on the hydraulic system power demand (Step 306). In the illustrated embodiment, the controller 114 may determine the hydraulic system power demand by receiving a pilot pressure signal or an electrical signal associated with the input device 106. The controller 114 may determine the desired parameter embodied as the engine speed of the engine at least in part based on the pilot pressure or electrical signal indicative of the hydraulic system power demand. In other words, the controller 114 may determine the optimal engine speed that is desired to meet the power demand required by the hydraulic system 108 as indicated by the pilot pressure or electrical signal. It is contemplated that the optimal engine speed may also be determined based on other factors, such as, for example, other pressures associated with the hydraulic system 108.

The controller 114 is further adapted to determine an actual parameter of the primary source 102 embodied as an actual engine speed of the engine (Step 308). The controller 114 compares the desired engine speed to the actual engine speed (Step 310). If the desired engine speed is greater than the actual engine speed (Step 310: Yes), the controller 114 compares the state of charge of the energy storage device 110 to the predetermined threshold (Step 312). The predetermined threshold may embody a state of charge sufficient to provide the power demanded by the hydraulic system 108, which may be the full capacity of the energy storage device 110 or a portion of the full capacity of the energy storage device 110. It is contemplated that the predetermined threshold may embody a range along a continuum of capacities. In other words, the controller 114 may be adapted to maintain the energy storage device 110 within a substantially constant range of storage capacity.

If the state of charge is greater than the predetermined threshold (Step 312: Yes), the controller 114 may provide power to the hydraulic system 108 as a function of the energy storage device power demand and the desired parameter (Step 314). It is contemplated that the controller 114 may also provide power to the hydraulic system 108 accordingly if the state of charge is substantially equal to the predetermined threshold. In other words, the controller 114 may provide power to the hydraulic system 108 in a manner to satisfy the hydraulic system power demand and to satisfy the desired engine speed. For example, a portion of the power is provided to the hydraulic system 108 from the engine 102 and a portion of the power is provided from the energy storage device 110 to maintain the desired engine speed while supplying the required power to meet the hydraulic system power demand.

Since providing power to the hydraulic system 108 from the engine 102 is a function of providing power from the energy storage device 110, the control system 112 may provide power to the hydraulic system 108 while the engine 103 is operating at a lower engine speed. In other words, the control system 112 may lower the actual engine speed and may allow the engine 102 to respond relatively quickly at very reduced engine speeds. In one embodiment, the energy storage device 110 embodied as a battery may be used to effectively meet a transient response of the hydraulic system 108. If the state of charge, however, is less than the predetermined threshold (Step 312: No), the controller 114 may provide power to the hydraulic system 108 entirely from the engine 102 (Step 316).

If the desired engine speed is less than the actual engine speed (Step 310: No), the controller 114 compares the state of charge of the energy storage device 110 to the predetermined threshold (Step 318). If the state of charge is less than the predetermined threshold (Step 318: No), the controller 114 may provide power to the energy storage device 110 from the engine 102 until the capacity of energy storage device 110 reaches the predetermined threshold level (Step 320). In other words, the controller 114 is adapted to provide power to the energy storage device 110 from the engine 102 if the state of charge of the energy storage device 110 is less than the predetermined threshold and the desired engine speed is lower than the actual engine speed.

It will be appreciated that the foregoing description provides examples of the disclosed systems and methods. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A method for providing power to a hydraulic system, the method comprising:
determining a hydraulic system power demand;
determining an energy storage device power demand;
determining a desired parameter of a primary power source based on the hydraulic system power demand; and
providing power to the hydraulic system as a function of the energy storage device power demand and the desired parameter.

2. The method of claim 1, wherein determining the hydraulic system power demand includes receiving at least one of either a pressure associated with the hydraulic system or an electrical signal associated with the hydraulic system.

3. The method of claim 2, wherein determining the hydraulic system power demand includes receiving a pilot pressure associated with an input device operatively connected to the hydraulic system; and determining the desired parameter of the primary power source includes determining a desired engine speed of an engine.

4. The method of claim 3, wherein determining the energy storage device power demand includes determining a state of charge of the energy storage device.

5. The method of claim 4, wherein providing power to the hydraulic system includes providing power in part from the engine and in part from the energy storage device.

6. The method of claim 5, the method further comprising:
comparing the desired engine speed to an actual engine speed; and
providing power to the hydraulic system in part from the energy storage device if the desired engine speed is greater than the actual engine speed.

7. The method of claim 6, the method further comprising:
comparing the state of charge to a charge threshold; and
providing power to the hydraulic system in part from the energy storage device if the state of charge is greater than the charge threshold.

8. The method of claim 7, the method further comprising:
providing power to the energy storage device from the engine if the desired engine speed is lower than the actual engine speed.

9. The method of claim 4, wherein providing power to the hydraulic system from the engine is a function of providing power to the hydraulic system from the energy storage device.

10. The method of claim 9, wherein providing power to the hydraulic system from the energy storage device results in the actual engine speed decreasing.

11. The method of claim 9, wherein providing power to the hydraulic system includes controlling a pump speed of a hydraulic pump operatively connected to the hydraulic system.

12. A system for providing power to a hydraulic system operatively connected to a primary power source, comprising:
a controller operatively connected to an energy storage device, the primary power source, and the hydraulic system, the controller adapted to:
determine a hydraulic system power demand;
determine an energy storage device power demand;
determine a desired parameter of a primary power source based on the hydraulic system power demand; and
provide power to the hydraulic system as a function of the energy storage device power demand and the desired parameter.

13. The system of claim 12, wherein determining the hydraulic system power demand includes receiving at least one of either a pilot pressure associated with or an electrical signal associated with an input device operatively connected to the hydraulic system.

14. The system of claim 12, wherein determining the desired parameter of a primary power source includes determining a desired engine speed of an engine, and determining the energy storage device power demand includes determining a state of charge of the energy storage device.

15. The system of claim 14, wherein the controller is further adapted to:
compare the desired engine speed to an actual engine speed; and
provide power to the hydraulic system in part from the energy storage device if the desired engine speed is greater than the actual engine speed.

16. The system of claim 15, wherein the controller is further adapted to:
compare the state of charge to a charge threshold; and
provide power to the hydraulic system in part from the energy storage device if the state of charge is greater than the charge threshold.

17. The system of claim 16, wherein the controller is further adapted to:
provide power to the energy storage device from the engine if the desired engine speed is lower than the actual engine speed.

18. The system of claim 17, wherein providing power to the hydraulic system from the engine is a function of providing power to the hydraulic system from the energy storage device, and providing power to the hydraulic system from the energy storage device reduces the actual engine speed.

19. A processor readable storage medium containing processor readable code for programming a processor to perform a method comprising:
determining a hydraulic system power demand by receiving a pilot pressure associated with an input device operatively connected to the hydraulic system;
determining a state of charge of an energy storage device;
determining a desired engine speed of an engine based in part on the pilot pressure; and
providing power to the hydraulic system in part from the engine and in part from the energy storage device as a function of the desired engine speed and the state of charge of the energy storage device.

20. A machine, comprising:
an engine;
an energy storage device;
a hydraulic system powered in part by the engine and in part by the energy storage device;
an input device operatively connected to the hydraulic system;
a controller operatively connected to the energy storage device, the engine, and the hydraulic system, the controller adapted to:
determine a hydraulic system power demand by receiving a pilot pressure associated with the input device;
determine a state of charge of the energy storage device;
determine a desired engine speed of the engine based in part on the pilot pressure; and
provide power to the hydraulic system in part from the engine and in part from the energy storage device as a function of the desired engine speed and the state of charge of the energy storage device.
